(19) United States
(12) Patent Application Publication
(10) Pub. No.: US 2007/0038484 A1
(43) Pub. Date: Feb. 15, 2007

(54) Methods and systems for health insurance claims submission and processing

(76) Inventors: Ronald M. Hoffner, Pomona, NY (US); Maksim Kneller, Bronx, NY (US)

Correspondence Address: WOLF BLOCK SCHORR AND SOLIS-COHEN LLP, 250 PARK AVENUE, NEW YORK, NY, 10177, US

(21) Appl. No.: 11/203,775

(22) Filed: Aug. 15, 2005

(51) Int. Cl. G06Q 40/00

(52) U.S. Cl. 705/4

(57) ABSTRACT

A system and method of submitting and processing health insurance claims includes displaying a request for claim information to an insured on a terminal connected to a network, entering the claim information by an insured via the terminal, generating an identification number associating the claim information with the health insurance claim, storing the identification number and at least a portion of the associated claim information on the network, and processing the claim information stored on the network.

### FIELD OF THE INVENTION

The present invention relates generally to methods and systems in the field of health insurance, and more particularly, to methods and systems for submitting and processing health insurance claims.

### BACKGROUND OF THE INVENTION

Health insurance reimbursement claims are presently submitted to insurers on paper-based forms that are completed by the insured claimants and usually mailed to the insurer. When a reimbursement claim form is received by the insurer, the claim information contained on the form is manually entered or transcribed into the insurer's computer system by a data entry operator employed by the insurer.

Oftentimes errors occur when claim information is transcribed incorrectly from the paper-based form into the insurer's computer system by the insurer's data entry operator. The information most commonly transcribed incorrectly includes the patient's name, the date of service, the amount of claim, and the service provider information. Payment is frequently mistakenly made to the provider instead of to the insured. The incorrect transcription of the claim information is not surprising since the information is generally complex and the data entry operator is typically not motivated to exercise the high degree of care and concentration necessary to avoid mistakes.

Errors also arise when subsequent submissions of claim information are made by the insured in connection with an earlier submitted claim. The subsequent submissions are not always correctly associated with the earlier claim, for example due to an incorrect claim number being designated on the subsequent submission.

As a result of these errors, the insured often receives an incorrect reimbursement payment. The insured must then spend a considerable amount of time corresponding with the customer service department of the health insurance company via telephone or mail in an effort to resolve the incorrect payment. Resolving the problem can be a frustrating process for the insured.

Another problem inherent in a paper-based mail system for processing health insurance claims is the relatively long time periods that frequently pass before an insured is either advised of the status of his or her claim, or the claim is acted upon.

Still another problem inherent in a completely paper-based claim submission and processing system is that it is not uncommon for the incoming claim form itself to become lost by the insurance company or mail service, which usually results in hours of time being wasted trying to locate the claim form.

A paper-based claim submission and processing system also is expensive to maintain due in part to the high cost to the insurer of manually transcribing or entering the information into the computer system, the need to reprocess incorrect claims, and the high cost of customer service support.

### OBJECTS AND SUMMARY OF THE INVENTION

Accordingly, a primary object of the present invention is to provide new and improved systems and methods for efficient and accurate health insurance claim submission and processing.

Another object of the present invention is to provide new and improved systems and methods for health insurance claim processing in which claim information is entered into the insurance company's computer system with greater reliability and accuracy than has been the case heretofore.

Still another object of the present invention is to provide new and improved systems and methods for health insurance claim submission in which supporting documents, such as the examination form signed by the doctor relating to a previously filed claim, which are submitted to the insurance company subsequent to the initial filing of the claims are reliably associated with the earlier filed claim.

A further object of the present invention is to provide new and improved systems and methods for health insurance claim processing in which insurance claimants are provided with frequent claim status notifications during the course of processing the claim.

Briefly, these and other objects are attained by providing systems and methods for submitting and processing insurance claims including the steps of displaying a request for claim information to an insured on a network computer terminal and having the insured, as opposed to an employee of the insurer, enter the claim information via the terminal. Preferably, the method also includes the steps of generating an identification number for association with the submitted claim information, associating and storing the identification number and at least a portion of the submitted claim information in a network storage device, and then processing the claim information stored on the network for payment of the claim.

The foregoing objects are also achieved by providing a system for submitting and processing health insurance claims via a network including a computer network, a storage location on the network, and an insured's terminal on the network for displaying a request for claim information, in response to which the requested claim information is entered by the insured and wherein at least a portion of the claim information entered by the insured is stored into the storage location on the network.

The system and method for processing insurance claims can be implemented by either an insurer or by a third party administration company acting on behalf of at least one insurer.

In a preferred embodiment, a request for claim information is displayed on a network terminal to which the insured has access. The insured accesses the displayed request via the network terminal, and enters the requested claim information himself or herself. An identification number is generated at the time the claim information is entered, and is saved on the network in association with at least some of the claim information entered by the insured. The claim information entered by the insured and saved in network storage is accessible to the insurer or the third party at another terminal. In the case of a third party, the claim information and the identification number are transmitted to the insurer by the third party.

According to the invention, the possibility of error in transcribing the information into the insured's computer system is significantly reduced by having the claimant or insured enter the data rather than a data entry operator employed by the insurer. The insured is more familiar with the requested data and has a greater incentive to accurately enter the data than does a data entry operator employed by the insurer since an accurate transcription of the data results in his/her claim being accurately and quickly processed and paid. The insurer is saved the time and expense inherent in having its employees transcribe the claim information into the insurer's database from a paper-based form.

According to another aspect of the invention, the insurer may also be requested to “key-verify” the claim information before the information is stored at the storage location. Key-verification virtually eliminates entry and omission errors in processing a health insurance claim. The identification number allows the insurer to quickly reference and retrieve the claim information from the network where it was saved.

After entering the claim information, a paper-based form is generated at the insured's computer terminal. The paper-based claim form contains at least some of the claim information already entered by the insured as well as the identification number generated at the time the claim information was initially entered. In the preferred embodiment, the identification number is in the form of a bar code.

According to another feature of a preferred embodiment, the insured then signs and mails or otherwise transmits the paper-based claim form along with additional requested claim documentation to the insurer. In a preferred embodiment, mailing labels with the insured's address can also be printed by the insured. The mailing labels may be used by the insured to mail the paper-based claim form and additional documentation to the insurer.

Upon receipt of the paper-based claim form, the insurer processes the claim by retrieving the stored claim information previously entered by the insured from network storage by referencing the computer-generated identification number. The identification number can be either manually entered by the insured or scanned if a bar code is being utilized. In the preferred embodiment, the insurer's data entry operator then manually enters information from the additional documentation included with the paper-based form or from other sources independent of the insured's submission to key-verify the claim information submitted by the insured. Key-verification prevents errors as well as fraud. The claim information in the insurer's database can be enriched by adding service information and internal codes. The claim can then be evaluated for reimbursement.

According to a preferred embodiment of the invention, status notifications are forwarded to the insured periodically during the claim processing. In a preferred embodiment, e-mails including the claim identification number are forwarded to the insured to confirm that all claim information has been gathered, to confirm receipt of the paper-based claim form and additional documentation, to request correction of an error or omission, to confirm that the claim has been accepted for reimbursement, and to inform the insured that the reimbursement check has been mailed. These e-mail notifications allow the insured to track the progress of processing the claim. They are also used to identify problems immediately, such as the failure of the insurer to receive the mailed paper-based claim form. This in combination with the claim identification number provide an efficient method for both the insurer and the insured to resolve any problems during the processing of a claim.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a schematic view of a system for submitting a health insurance claim to an insurer and for processing that claim, according to the present invention;

FIG. 2 is a schematic view of a system for submitting a health insurance claim to an insurer via a third party and for processing that claim, according to the present invention;

FIG. 3 is a flow chart showing a method for submitting a health insurance claim to an insurer according to the present invention.

FIG. 4 is an introductory screen used in an embodiment of the present invention;

FIG. 5 is a registration screen used in an embodiment of the present invention;

FIG. 6 is a login screen used in an embodiment of the present invention;

FIG. 7 is a welcome screen used in an embodiment of the present invention;

FIG. 8 is an insurance plan screen used in an embodiment of the present invention;

FIG. 9 is a dependents screen used in an embodiment of the present invention;

FIG. 10 is a providers screen used in an embodiment of the present invention;

FIG. 11 is a claim screen used in an embodiment of the present invention;

FIG. 12 is an e-mail notification of electronic claim submission used in an embodiment of the present invention;

FIG. 13 is a compiled claim form screen used in an embodiment of the present invention;

FIG. 14 is a filing instructions screen used in an embodiment of the present invention;

FIG. 15 is an e-mail notification of mail receipt of claim used in an embodiment of the present invention;

FIG. 16 is a key-verification and claim enrichment screen used in an embodiment of the present invention; and

FIG. 17 is an e-mail notification of completion of processing used in an embodiment of the present invention.

### DETAILED DESCRIPTION OF THE INVENTION

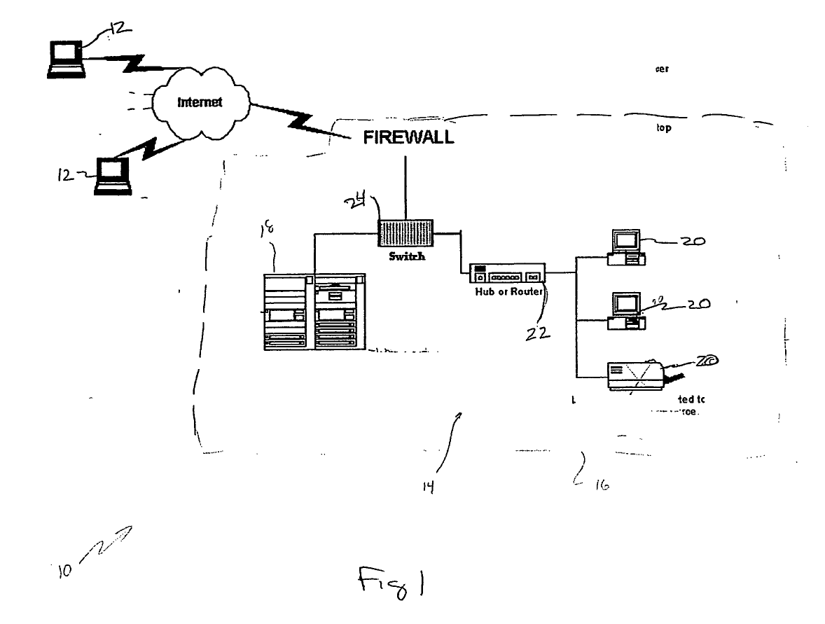

Referring now to the drawings wherein like reference characters designate identical or corresponding parts throughout the several views, and more particularly to FIG. 1, a first embodiment of a system for submitting and processing a health insurance claim is generally designated 10. The system 10 is designed to be implemented by a health insurance company (hereinafter “insurer”), as opposed to a third-party provider.

The system 10 comprises a plurality of insured computer terminals 12 connected through the Internet to an insurer's network 14 situated at the premises of the insurer 16. The insurer's network 14 includes a server 18 which runs the software and hosts a website for implementing the method of the invention. The server 18 also functions as a file server for document and data management and storage for the insurer's computer terminals 20 on the network. The insurer's computer terminals 20, which are generally operated by data entry operators, are connected to the server 18 through a hub 22 and switch 24 as is conventional.

According to the invention, individuals that have health insurance policies with the insurer (hereinafter, “insured”) can access the website hosted by server 18 through the Internet using standard personal computers which function as insured computer terminals 12. Each insured computer terminal 12 also is connected to a local printer which is used in connection with submitting health insurance claims as described below.

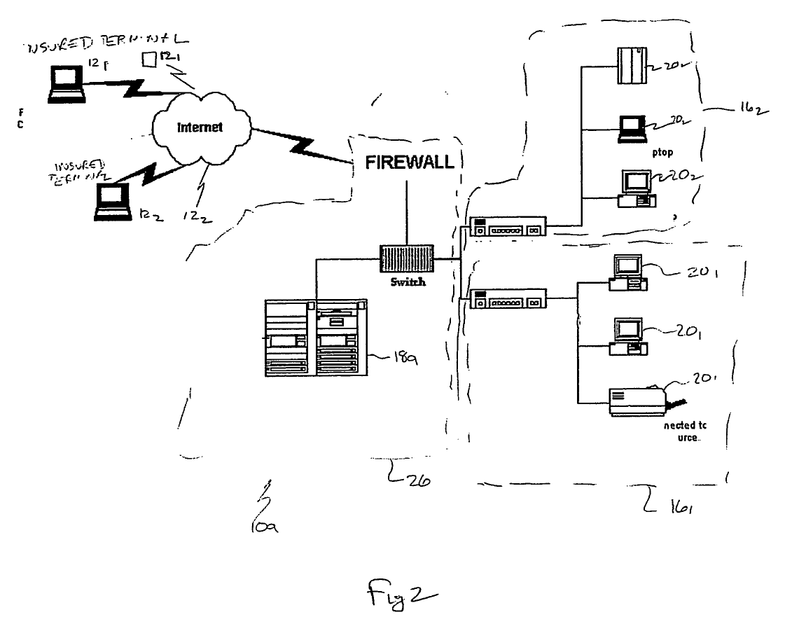

Referring to FIG. 2, a second embodiment of a system in accordance with the invention is generally designated 10a. System 10a is designed to be implemented by a third-party service provider 26 and provides claim services in accordance with the invention to one or more insurance companies 16₁, 16₂ . . . . A server 18a is situated on the premises of the third-party provider 26 and is connected to the insurer's computer terminals 20₁, 20₂ . . . situated at the premises of insurers 16₁, 16₂ . . . , respectively. Individuals having health insurance policies with insurer 16₁ can access the website hosted by server 18a on behalf of insurer 16₁ through the Internet from insured's computer terminals 12₁. Similarly, individuals having health insurance policies with insurer 16₂ can access the website for insurer 16₂ hosted on server 18a through the Internet using insured's computer terminals 12₂.

Generally, a system in accordance with the invention operates as follows. An insured who desires to submit a claim to his or her health insurance company accesses the insured's website hosted on server 18 at an address provided by the insurer through the Internet using an insured computer terminal 12. The website includes a screen that prompts or requests the insured to enter certain general information as well as certain information specific to the particular claim being submitted. The insured enters the requested information via his/her computer terminal 12. Prior to transmitting the data to the server 18 the system generates an identification number unique to the new claim being submitted and associates the identification number with the claim data entered by the insured. The claim information and associated identification number are sent over the Internet to server 18 where the data is stored. The information is accessible to the data-entry operators at insurer terminals 20 over network 14 for subsequent processing. The fact that according to the invention it is the insured that enters the claim data into the insurer's network rather than a data entry person employed by the insurer as in the prior art greatly improves the likelihood that the data is entered accurately. Not only can the insured enter the data more slowly and carefully than the insurer's data entry operator, who usually is responsible for entering the information for a large number of claims in a short time period, but the insured has a much greater incentive to accurately enter the claim data than does the insurer's employee since it is the insured who will directly benefit from an accurate entry of the data in the form of quick and efficient processing of the claim.

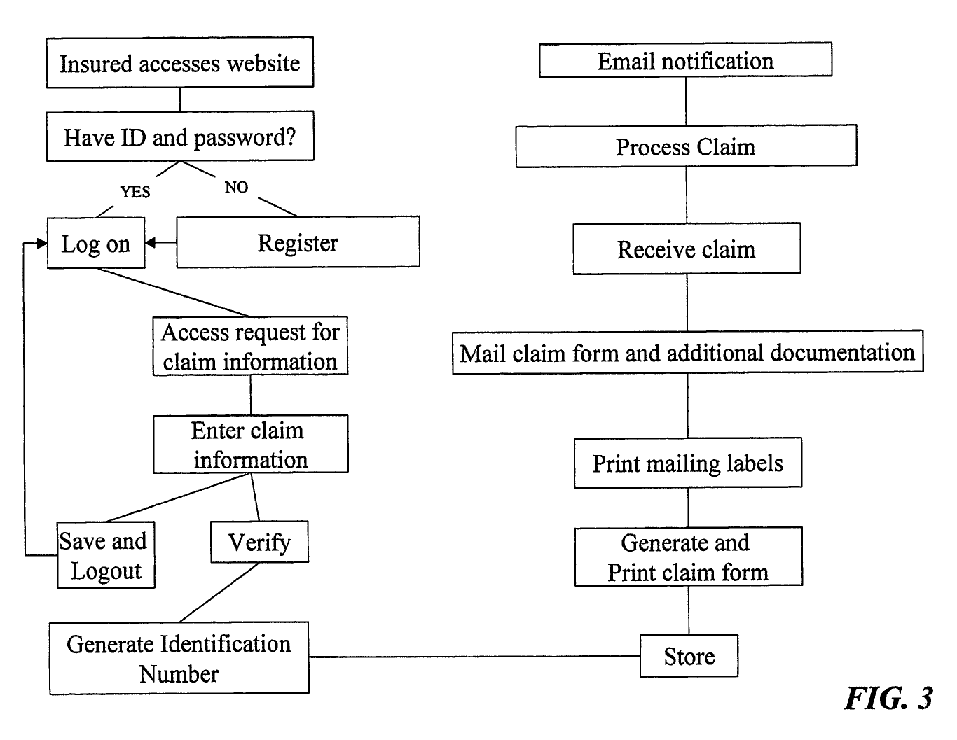

Referring to FIG. 3 which shows a flow chart of the steps of a method for submitting and processing health insurance claims in accordance with the invention, initially, an insurer or a third party provider hosts a website on the server 18 which requests claim information from an insured desiring to submit a health insurance claim. The insured uses the insured's terminal 12 to access the website at an address, such as a URL, provided by the insurer. The website contains a request for claim information which is displayed on the insured's terminal 12 when the website is accessed. The request for claim information may be completed online or downloaded onto the insured's terminal 12 to be completed at a later time.

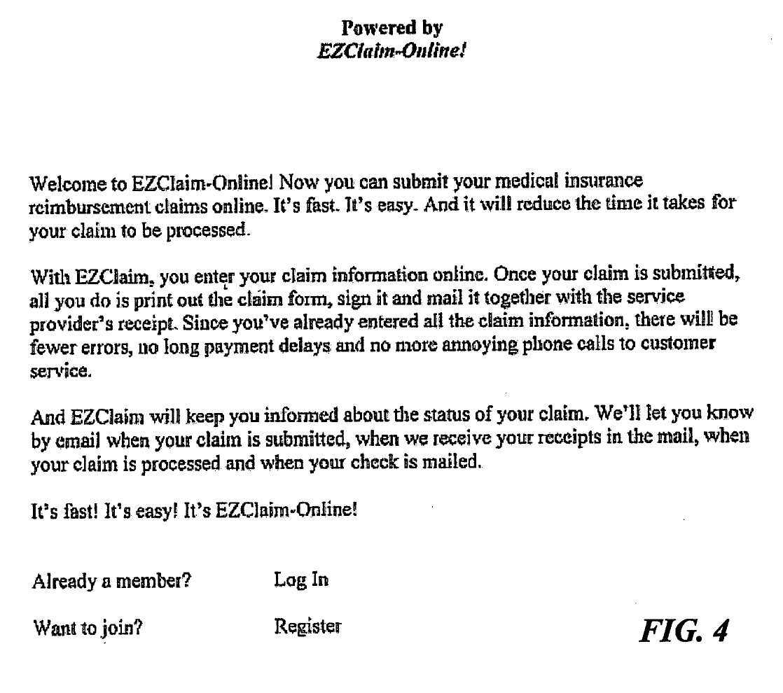

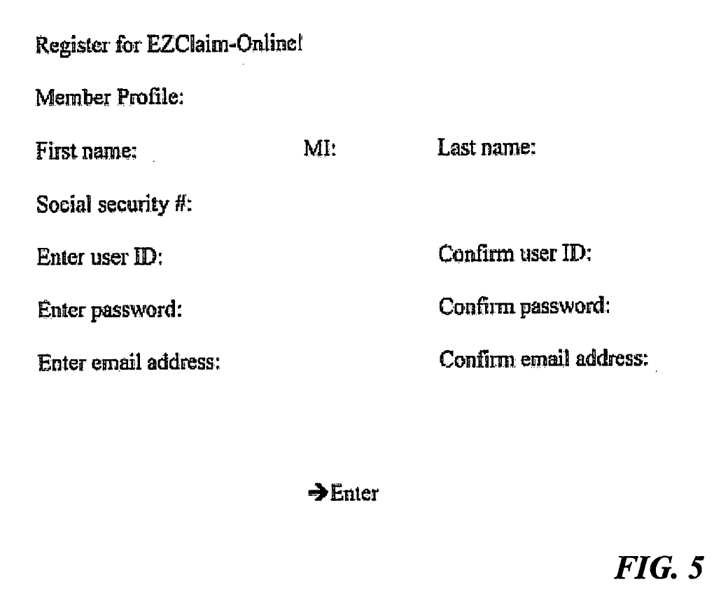

The first screen of the website, an example of which is shown FIG. 4, provides a welcome to the website, instructions on how to complete the claim forms and a format to log in and register. The first time the insured uses the website, he or she must register by creating a unique user ID and password. FIG. 5 shows a screen that may be used to register the insured. The screen requests general data including user identification information such as name, social security number, and email address. The insured is also requested to create a user ID and password. The insured is requested to confirm the user ID, password, and email address to prevent typographical errors.

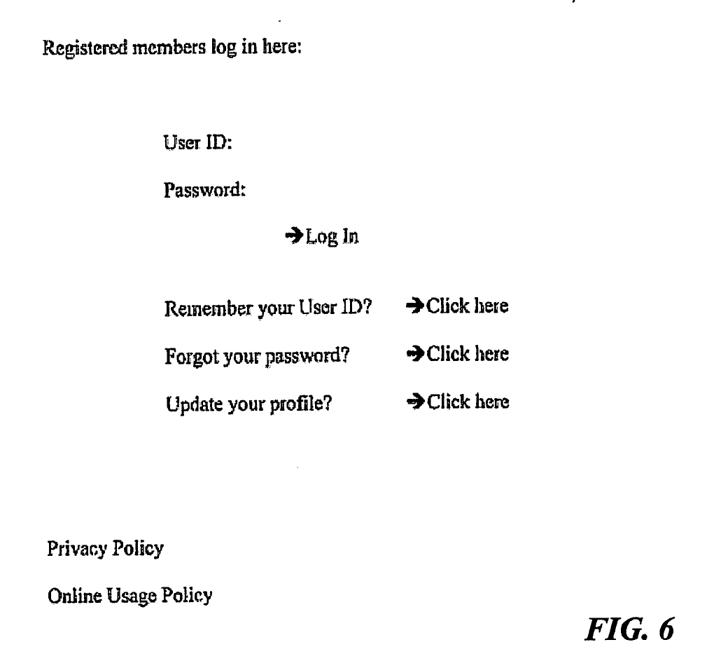

The insured is required to use the user ID and password each time the website is accessed to submit a new claim. An example of a screen that may be used to log in to the website is shown in FIG. 6. The insured is requested to enter the user ID and Password previously created and click the Log In button. It is understood that the insured may change the user ID and/or password. This can be achieved by clicking the “Update your profile” button. Also, if the insured forgets the user ID and/or password, there is a procedure for gaining access to the previously stored user ID and/or password. The log in screen may also contain a link to the website's privacy policy and online usage policy. A cookie may be placed on the insured's computer so that the insured is automatically identified upon accessing the website.

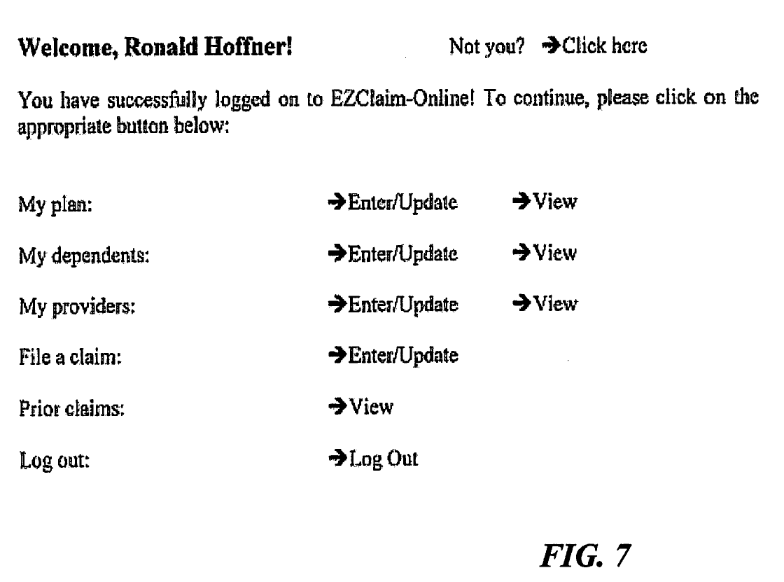

Once the insured is logged in, an appropriate claim form is accessed. There may be different forms for different types of claims. Different insurance companies may require different forms. Also, an insured may have previous claims that have not yet been submitted. The desired claim form is chosen and may be completed by the insured on-line using the insured's terminal 12. The insured navigates through the website entering the various types of requested claim information. The insured may not be required to enter all the requested claim information. A menu screen (FIG. 7) is provided on the website to navigate to the various requests for claim information. The main menu contains a list of all actions the insured can take in connection with submitting his or her claim. These actions include updating or viewing the insured's personal information such as insured's health insurance plan, dependents, and healthcare providers. Other actions include filing a new or partially completed claim, viewing prior claims, and logging off the website.

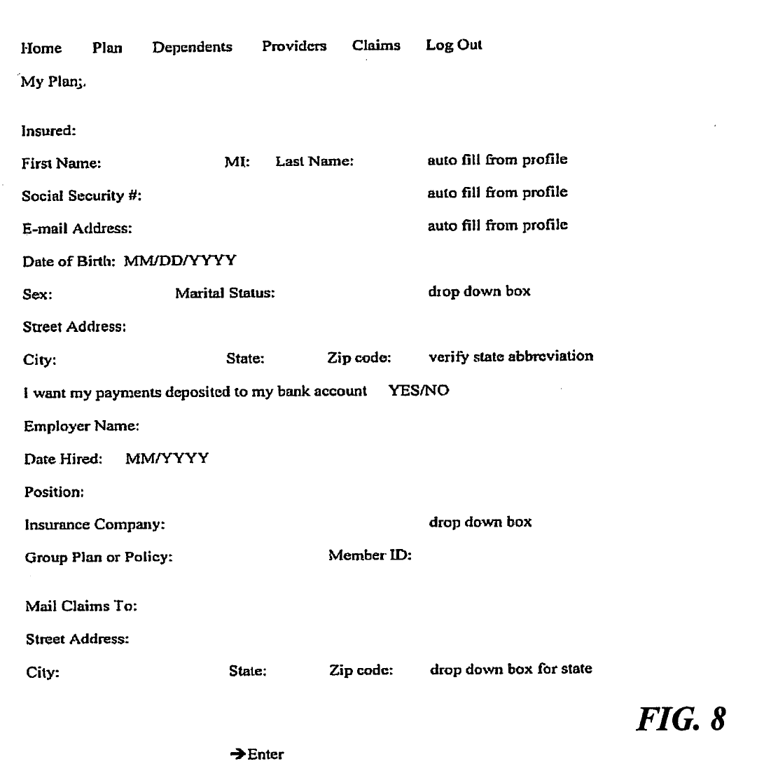

Upon clicking the link to update or view the insured's plan, the insured is brought to the insured's plan screen. FIG. 8 is an example of a insured's plan screen. At the insured's plan screen, the insured enters plan information (e.g. name, address, date of birth, social security number, telephone number, policy number, etc.). The screen may also contain an option that allows the insured to specify how reimbursement is to be received. Options may include receiving reimbursement by mail via a check or by electronic payment deposited directly to insured's specified bank account. A response to a request for the insured's bank account information would also have to be made with the latter option. This screen, as well as several other screens, provides a menu with links to other areas of the website which allows the insured to navigate directly to a desired area of the website.

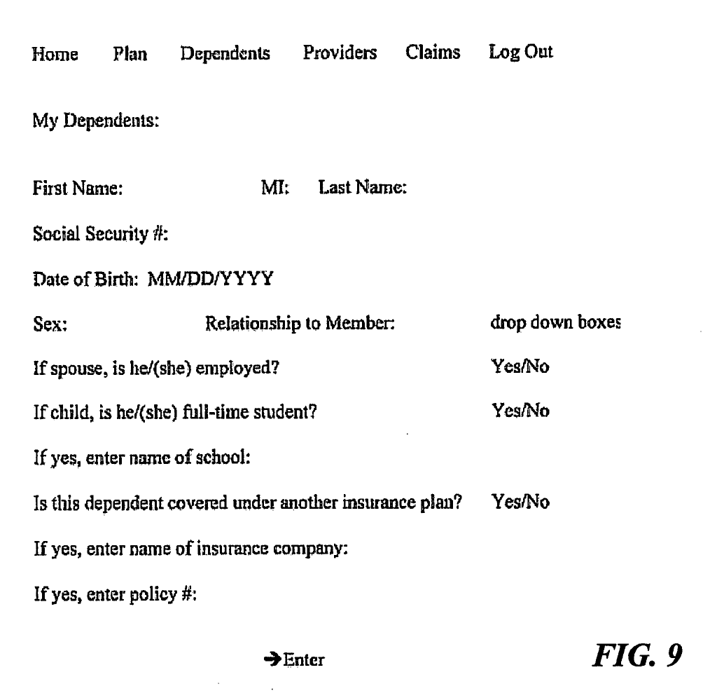

Upon clicking the dependents link, the insured's dependents screen is accessed. FIG. 9 is an example of an insured's dependents screen. This screen requests information regarding the insured's dependents.

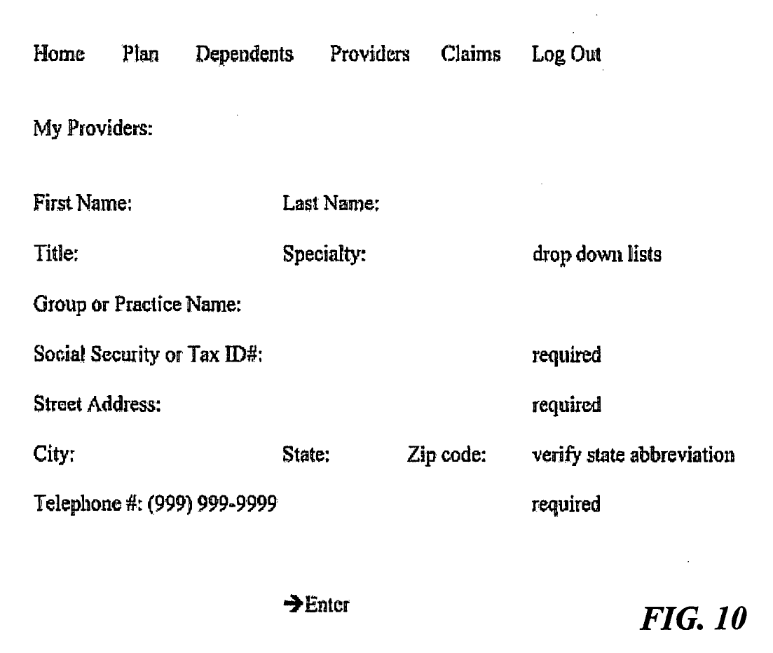

FIG. 10 is an example of an insured's health care providers screen that is accessed by clicking on the providers link. This screen prompts the insured to provide information regarding the insured's doctors/providers.

It is understood that the foregoing personal information (i.e. information regarding insured's plan, dependents, and providers) may be permanently stored at the server 18 so that the insured may retrieve the information at the website each time a new claim form is completed and submitted. Additionally, the personal information may be identified in drop down lists on other screens of the website.

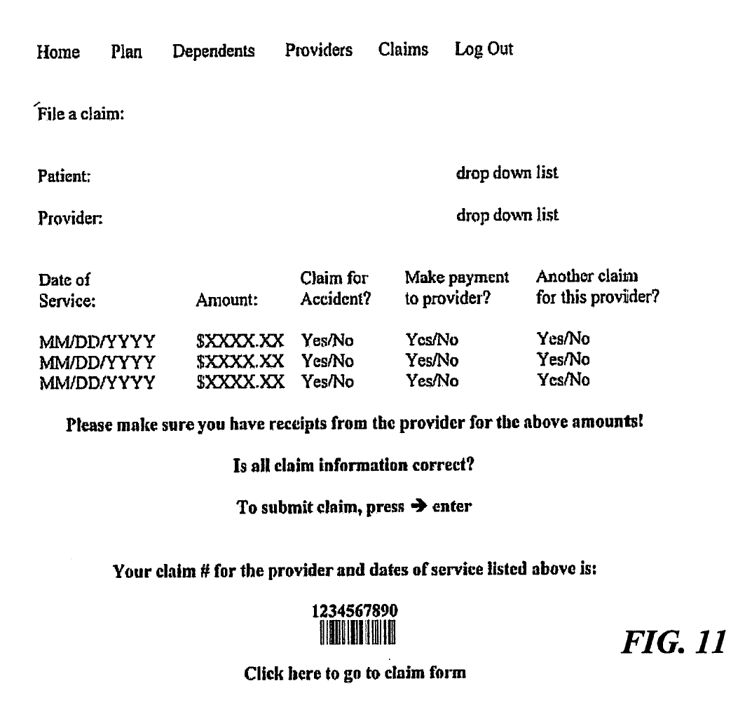

The insured accesses the claim form by clicking on the claims link of the new menu (FIG. 7). The insured may then select his or her new claim in the case it is desired to submit a new claim or a prior incomplete claim. FIG. 11 shows an example of a claim screen which prompts the insured to enter certain claim information specific to a new claim being made. The insured enters the patient name and provider name. In a preferred embodiment, the patient and provider names are chosen from drop down menus that are formulated based on the personal information entered earlier by the insured. The insured also enters data specific to the particular claim, the date of treatment, e.g., amount of fee, type of treatment, any prescriptions, etc. The screen provides for multiple claims to be made at the same time.

When there is insufficient time, or when the insured does not have all of the necessary information, to complete the form in a single session, the partially completed forms can be stored and saved at the storage location on server 18 for completion at a later time. The partially completed claim form is saved for a specified time period such as 30, 60 or 90 days, or any other desired period of time. The insured will use his/her user ID and password to sign-on to the system at a later time to complete the form.

After the insured finishes entering the requested claim information, the insured is requested to review the claim form and confirm that the information entered is correct. The insured can make any necessary changes to the claim form. Once all of the basic and specific information has been entered, and the insured is satisfied that all of the information is correct, the insured submits the claim form by clicking the “enter” button. The information is transmitted to and stored on the storage location of server 18.

The claim information stored in server 18 is accessible to at least the insurer. The claim information may also be accessible to the insured as a historical record of the previous claims submitted by the insured.

According to an important aspect of the invention, an identification number is generated and associated with the claim information entered by the insured. It is understood that the identification number may be generated at any point after the first time the insured accesses a claim form to immediately before the information is transmitted and stored on the server 18. The identification number is ultimately used by the insurer to identify and retrieve the claim information.

Where the server 18a (FIG. 2) is operated by a third party 26, a file is created for transmission to the insurer with claim information and identification number, as will be discussed in further detail below. The file remains pending until the paper based claim form is received by the insurer as described below.

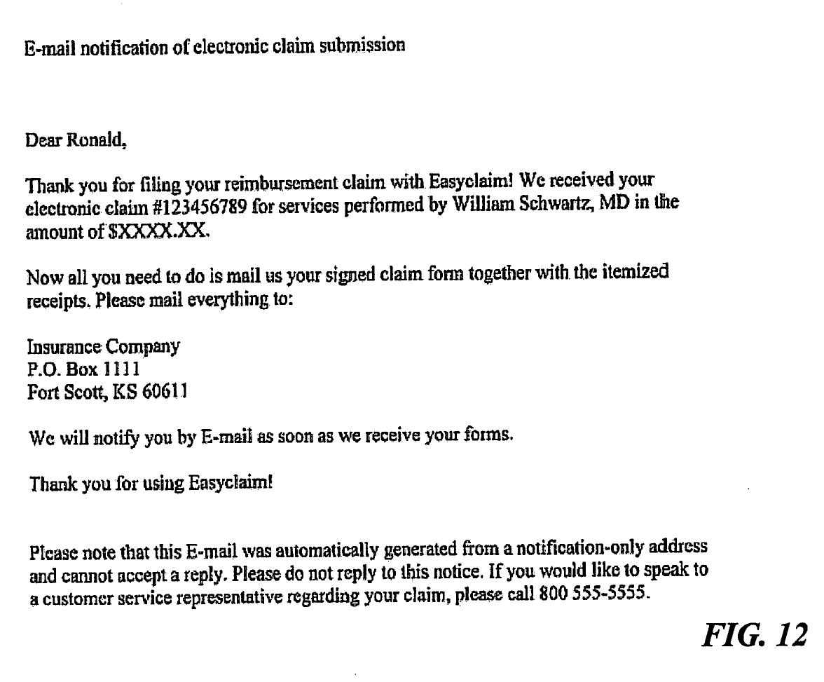

In a preferred embodiment, status notifications, preferably in the form of e-mails, are automatically generated and sent to the insured confirming receipt of the claim information submission via the website. FIG. 12 is an example of an e-mail notification of the electronic claim submission. The email contains some of the claim information, such as the identification number, the service provider, the amount of the claim, etc. The email may also contain further instructions regarding claim processing.

In a preferred embodiment, the insured's terminal 12 is used to generate a printed paper-based claim form containing at least a portion of the claim information entered by the insured and the identification number. The paper-based claim form may contain the identification number in the form of a bar-code or in alphanumeric format. The insured will print the claim form using the insured's own computer printer to create a paper-based claim form. Preferably, two copies of the paper-based claim form are printed so that the insured may have a copy for the insured's records. The completed claim form is printed with the bar code in such a format that facilitates bar code scanning and retrieval of data related to that particular claim form. It is understood that the claim form need not be printed if the insurer does not require a paper-based claim form or a claim form signed by hand.

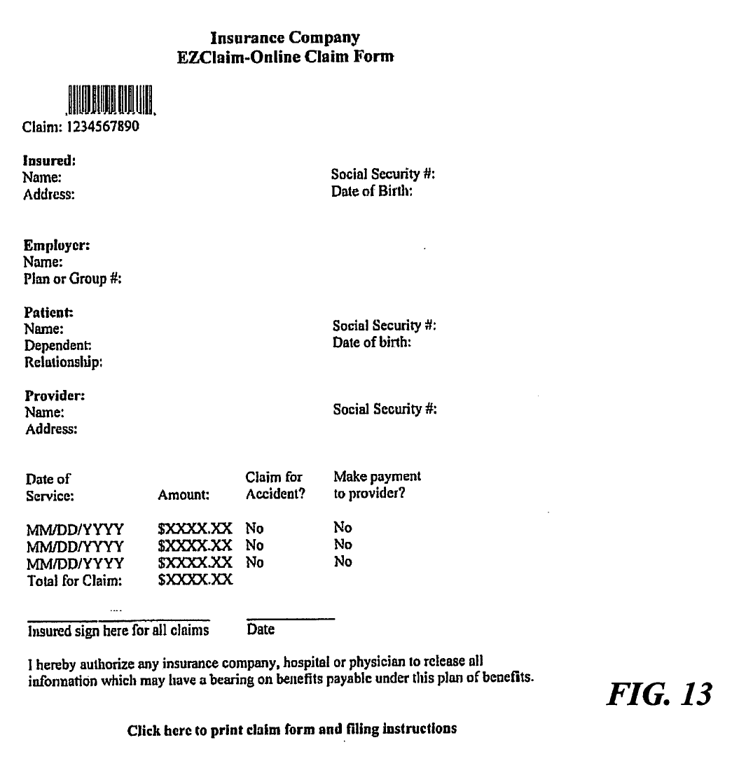

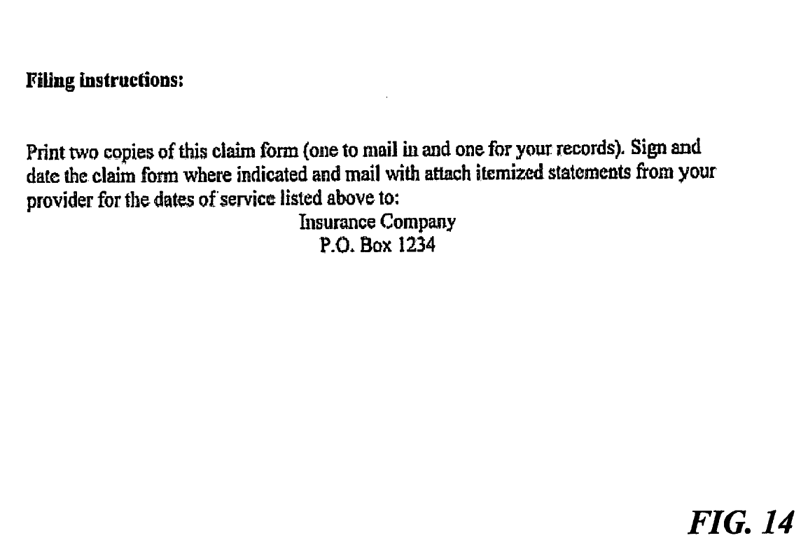

An example of the printable claim form screen shown in FIG. 13. The printable claim form contains the bar code and claim number as well as at least some of the personal information and claim information provided by the insured. A signature line and date line are provided for the insured to fill out once the paper-based form is created by printing the printable claim form screen. A button is provided which causes the printable claim form as well as filing instructions and mailing labels to be printed. FIG. 14 is an example of filing instructions. The filing instructions include mailing instructions and a listing of other documentation required for reimbursement. The mailing labels contain the address of the insurer for ease in submitting the claim form.

The insured may sign and date the paper-based claim form where indicated. Additional supporting documentation (e.g. healthcare provider's invoices, lab work receipts, etc.) is attached and a completed reimbursement claim package is sent by the insured to the insurer using the mailing label and a mail service provider. It is understood that where appropriate, the insured may scan the signed claim form and additional supporting documentation and send them to the insurer in an electronic form, such as in .pdf format. Furthermore, it is understood that the insured need not send the paper-based claim form nor supporting documentation if not required to do so by the insurer.

Upon receipt of the paper-based claim form, the data entry operator retrieves the previously entered claim data from server 18 by entering the identification number at a terminal 20 The data entry operator can input the identification number manually into the insurer's terminal 29, or in the preferred embodiment, the operator can scan the identification number in the form of a bar code on the paper-based form with a scanner coupled to the insurer's terminal. Scanning the bar code provides a faster and error-free method of inputting the identification number.

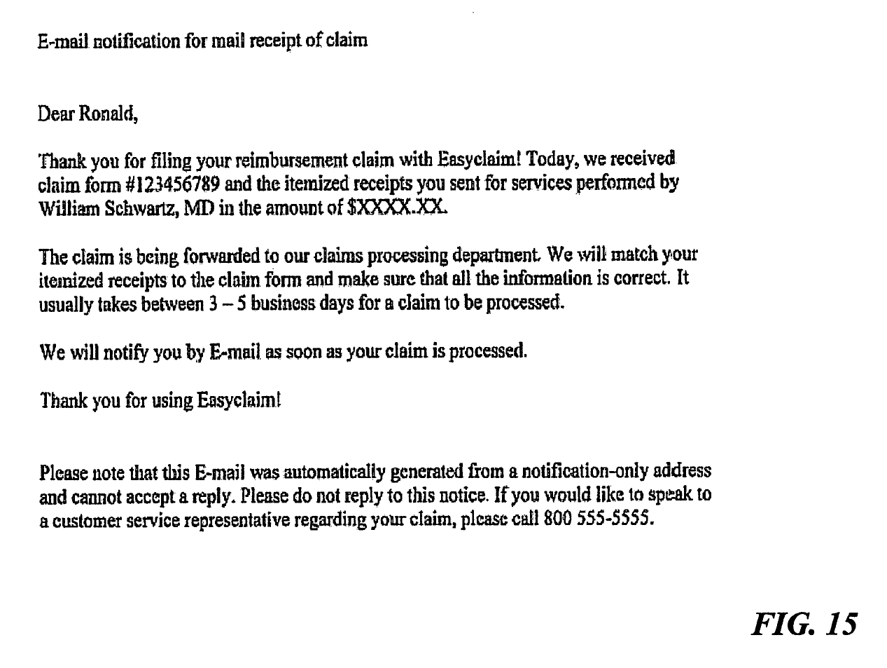

Once a paper-based claim form and any additional supporting documentation are received by the insurer and the identification number has been entered, an e-mail notification is sent to the insured confirming receipt of the paper-based claim form. The e-mail notification may be automatically generated. The insured's e-mail address may be obtained from the claim information on the server 18. An example of an e-mail notifying the insured that the paper-based claim form has been received by the insurer is provided in FIG. 15. The email contains some of the claim information, such as the identification number, the service provider and the amount of the claim. The e-mail may also contain information explaining the steps remaining in processing the claim.

As discussed above, the data entry operator scans the identification number from the paper-based claim form using the insurer's terminal 20 and retrieves claim information from the storage location of server 18 associated with the identification number. The claim information is displayed on the insurer's terminal 20.

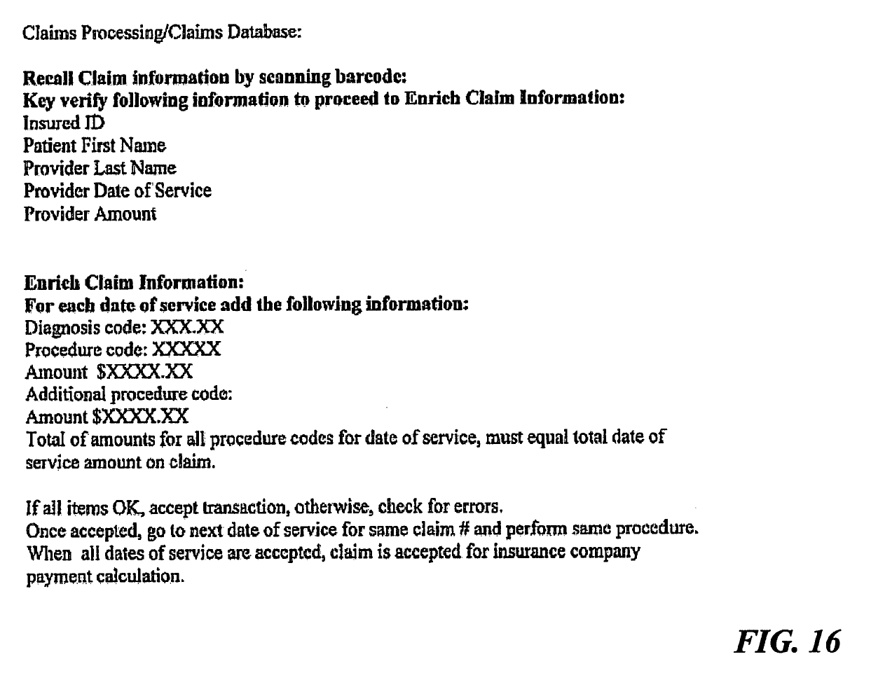

In the preferred embodiment, the previously stored claim information is key-verified by the data entry operator to confirm its accuracy. The insurer does so by entering information at the insurer's terminal 20 obtained from the supporting documentation and paper-based claim form submitted by the insured or from independent sources. An example of information gathered from independent sources which may be used for verification is a record of service submitted by the provider directly to the insurer. The claim information previously entered by the insured is then verified by comparing the information entered by the insurer to the information submitted by the insured. FIG. 16 shows an example of a screen that may be used in the key-verification step. The screen lists information that should be key-verified by the data entry operator using the supporting documentation or other information gathered independent of the previously submitted information. The information may include insured's ID, insured's name, provider's name, date of service, and amount of service.

If no discrepancy is found between the claim information entered by the insured and the verification information, then the claim is accepted for insurer payment calculation. If a discrepancy is found, the insurer first ascertains whether the key-verification information was entered correctly. If it is found that the claim form is not filled out correctly or additional supporting information is missing, the insurer may notify the insured by e-mail, regular mail, and/or telephone that more information is necessary to process the claim. In situations where the information entered by the insured is clearly erroneous, a supervisor at the insurer may override the entered information and change the entry. Key-verification insures that the insured did not err or omit any information in filing the claim. The use of key-verification also prevents insurance claim fraud.

Additional information such as diagnosis codes and procedure codes may be entered into database by the insurer using the insurer's terminal 20 for each date of service to enrich the claim information. The total amounts for all procedure codes for each date of service must equal the total date of service amount in the claim. This data is generally the insurer's internal data that assists in record keeping or has other business functionality. FIG. 16 is an example of a screen created by the software and displayed on the insurer's computer terminal that can be used to enrich the claim information. The screen requests input of procedure and diagnosis codes as well as the amount for each procedure code.

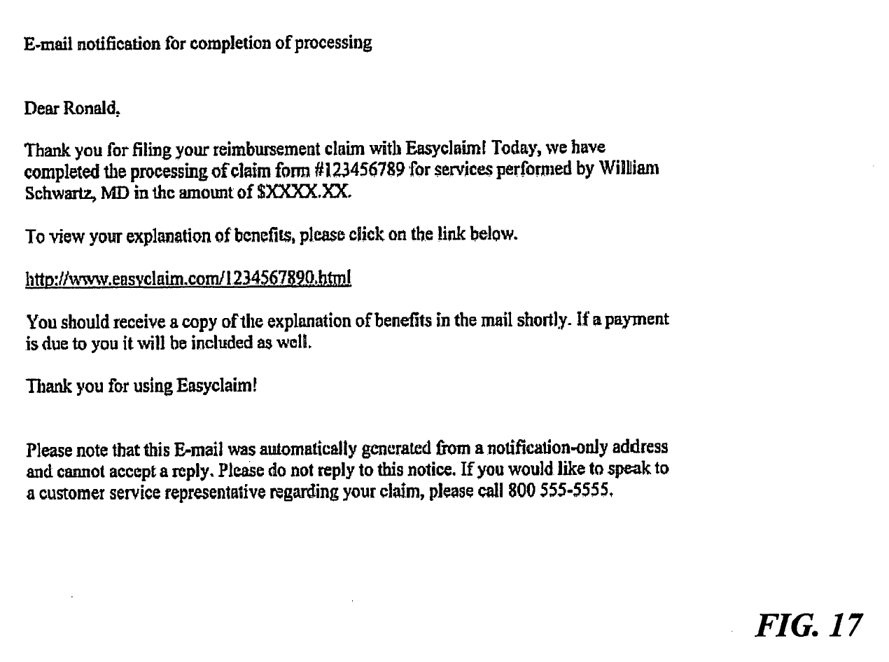

Once the processing of the claim is completed, the insured receives an e-mail notification informing the insured that the processing is complete. The e-mail notification may be automatically generated. The insured's e-mail address may be obtained from the claim information stored in the server 18. An example of an e-mail notifying the insured of completion of processing is shown in FIG. 17. The e-mail contains some of the claim information, such as the identification number, the service provider, the amount of the claim, etc. The e-mail may also contain a link to an explanation of benefits (EOB) as well as any payment due to the insured. The insured has the option of viewing the EOB on the website which is indicated in the e-mail notification. It is understood that an e-mail notification may be sent at any point during the claim processing.

It is understood that the system 10 may also be used to generate a health insurance claim form. A request for claim information is displayed to the insured on the insured's terminal 12. The insured enters the requested claim information using the insured's terminal 12. An identification number is generated associating the claim information with the health insurance claim. A claim form is generated including at least a portion of the claim information entered by the insured and the identification number. Finally, the insured uses a local printer to print the claim form.

Although the present invention is shown in FIGS. 1 to 17 with the system and method for submitting and processing a health insurance claim described above, it is understood and within the scope of the present invention that the features of the present invention may be used with any health-related process that requires submission of paper documentation for reimbursement or payment of a claim, such as dental healthcare or prescription reimbursements. Thus, the present invention is not limited to the specific features and embodiments described above.

I claim:

1. A method for submitting an insured's health insurance claim to an insurer or a third party via a network and processing said claim, comprising the steps of:
displaying a request for claim information to said insured at a terminal on said network;
entering said requested claim information by said insured via said terminal;
generating an identification number associating said claim information with said health insurance claim;
storing on said network at a location accessible to at least one of said insurer and third party said identification number and at least a portion of said claim information; and
processing said claim information stored on said network.

2. A method according to claim 1 further comprising the step of storing said claim information on said network at a location accessible to at least one of said insurer and insured as a historical record.

3. A method according to claim 1 wherein said health insurance claim is initially submitted by said insured to said third party, further comprising the step of said third party transmitting to an insurer at least a portion of said claim information entered by said insured and said identification number.

4. A method according to claim 1 further comprising the step of printing a paper-based claim form including said identification number and at least a portion of said claim information entered by said insured, and mailing by the insured said paper-based claim form and any additional documentation to said insurer.

5. A method according to claim 4 wherein said step of processing said claim information comprises utilizing said identification number to retrieve said claim information stored on said network.

6. A method according to claim 4 wherein said identification number is in the form of a bar-code.

7. A method according to claim 4 wherein said step of processing said claim information further comprises key verifying said claim information stored on said network utilizing said additional documentation.

8. A method according to claim 4 wherein said step of processing said claim information further comprises sending status notifications to said insured during said processing.

9. A method according to claim 4 wherein said step of processing said claim information further comprises enhancing said claim information stored on said network.

10. A method according to claim 4 further comprising the step of printing mailing instructions by said insured.

11. A method for generating a claim form for an insured's health insurance claim comprising the steps of:
displaying a request for claim information to said insured at a terminal on a network;
entering said requested claim information by said insured via said terminal;
generating an identification number associating said claim information with said health insurance claim;
generating a claim form including at least a portion of said claim information entered by said insured and said identification number; and
printing said claim form.

12. A system for submitting and processing a health insurance claim comprising:
a network;
a storage location on said network; and
an insured's terminal on said network for displaying a request for claim information, entering by the insured said requested claim information, and for storing said claim information on said storage location on said network.

13. A system as in claim 12 further comprising an insurer's terminal on said network for accessing and processing said claim information stored on said storage location.

14. A system as in claim 12 wherein said storage location is operated by a third party.

15. A system as in claim 14 further comprising an insurer's terminal coupled to said storage location operated by said third party such that said third party may provide said insurer's terminal with said claim information.
